(19) United States
(12) Patent Application Publication
(10) Pub. No.: US 2018/0273335 A1
(43) Pub. Date: Sep. 27, 2018

(54) CASE SEALER INCLUDING A TAPE CARTRIDGE WITH A PIVOTABLE CUTTING DEVICE

(71) Applicant: Signode Industrial Group LLC, Glenview, IL (US)

(72) Inventors: Bryce J. Fox, Honesdale, PA (US); Robert Mahon, Milford, PA (US)

(21) Appl. No.: 15/926,345

(22) Filed: Mar. 20, 2018

Related U.S. Application Data
(60) Provisional application No. 62/474,832, filed on Mar. 22, 2017.

(51) Int. Cl. B65H 35/00; B65B 51/06; B31B 70/81; B65B 51/28

(52) U.S. Cl. CPC B65H 35/0033; B65B 51/06; B65B 51/28; B65H 35/0086; B31B 70/81

(57) ABSTRACT

Various embodiments of the present disclosure provide a case sealer including a tape cartridge with a pivotable cutting device.

### PRIORITY CLAIM

This application claims priority to and the benefit of U.S. Provisional Patent Application No. 62/474,832, filed Mar. 22, 2017, the entire contents of which are incorporated herein by reference.

### FIELD

The present disclosure relates to case sealers, and more particularly to a case sealer including a tape cartridge with a pivotable cutting device.

### BACKGROUND

Every day, companies around the world pack millions of items in cases (such as cardboard boxes) to prepare them for shipping. Many of these companies use semiautomatic or fully automatic case sealers to (at least partially) automate the packing process, and particularly to automate sealing the cases with pressure-sensitive packing tape. A typical case sealer includes a tape cartridge that, in operation, automatically applies packing tape to the cases to seal them.

One known tape cartridge includes a front roller arm assembly, a cutting assembly, a rear roller arm assembly, a tape mounting assembly, and a tension roller assembly. A roll of packing tape is mounted to the tape mounting assembly. A free end of the packing tape is routed through several rollers of the tension roller assembly until the free end of the packing tape is adjacent a front roller of the front roller arm assembly with its adhesive side facing outward.

To seal a case, a drive assembly of the case sealer moves the case relative to the tape cartridge. This movement causes the front roller of the front roller arm assembly to contact a leading surface of the case and apply the packing tape to the leading surface. Continued movement of the case relative to the tape cartridge forces the front roller arm assembly to retract, which causes the rear roller arm assembly to retract since the roller arm assemblies are linked. As the drive assembly continues to move the case relative to the tape cartridge, the front roller rides along the top surface of the case while applying the packing tape to the top surface. A rear roller of the rear roller arm assembly also rides along the top surface of the case (once the case reaches it).

As the drive assembly continues to move the case relative to the tape cartridge, the case contacts the cutting assembly and causes it to retract and ride along the top surface of the case. Once the drive assembly moves the case relative to the tape cartridge such that the case's trailing surface passes the cutting assembly, a biasing element biases the cutting assembly back to its original position. Specifically, the biasing element biases an arm with a toothed blade fixedly attached to the arm downward to contact the packing tape. After contacting the packing tape, continued downward movement of the arm and the blade cause the teeth to drag along the packing tape before finally severing it from the roll, leaving a free trailing end of the packing tape. At this point, the rear roller continues to ride along the top surface of the case, thereby maintaining the front and rear roller arm assemblies in their retracted positions.

Once the drive assembly moves the case relative to the tape cartridge such that the case's trailing surface passes the rear roller, biasing elements force the front and rear roller assemblies to return to their original positions. As the rear roller assembly does so, it contacts the trailing end of the severed packing tape and wipes it onto the trailing surface of the case.

The impact of the teeth of the blade onto the packing tape combined with its dragging along the tape imparts significant force to the teeth. Repeatedly imparting these forces on the teeth eventually stresses them to the point of bending or breaking. When this happens, an operator must stop the case-sealing process and replace the blade. The higher the throughput, the quicker the teeth bend or break and the more often the blade needs replacement.

Also, dragging the teeth of the blade across the tape generates small shards of packing tape that often stick to the blade. The shards accumulate over time, which negatively impacts blade performance and can render the blade unable to adequately sever the packing tape. Alternatively, the shards could fall off of the blade but leave a sticky residue, which accumulates over time and negatively impacts blade performance In either scenario, an operator must stop the case-sealing process and either clean or replace the blade. Again, the higher the throughput, the quicker the shards and/or adhesive accumulate on the blade and the more often the blade needs to be cleaned.

There is a need for new and improved case sealers that solve these problems.

### SUMMARY

Various embodiments of the present disclosure provide a case sealer including a tape cartridge with a pivotable cutting device. In one embodiment, the case sealer includes a drive assembly configured to move a case and a tape cartridge configured to apply tape to the case. The tape cartridges includes a mounting plate, a first roller arm assembly supported by the mounting plate and including a first roller arm pivotable relative to the mounting plate between a first roller arm extended position and a first roller arm retracted position, a second roller arm assembly supported by the mounting plate and including a second roller arm pivotable relative to the mounting plate between a second roller arm extended position and a second roller arm retracted position, and a cutting assembly supported by the mounting plate. The cutting assembly includes a support arm pivotable relative to the mounting plate between a support arm extended position and a support arm retracted position, a cutting device mount pivotable relative to the support arm between a first position and a second position, and a biasing element that biases the cutting device mount to the first position.

Various embodiments of the present disclosure provide a tape cartridge with a pivotable cutting device. In one embodiment, the tape cartridge includes a mounting plate, a first roller arm assembly supported by the mounting plate and including a first roller arm pivotable relative to the mounting plate between a first roller arm extended position and a first roller arm retracted position, a second roller arm assembly supported by the mounting plate and including a second roller arm pivotable relative to the mounting plate between a second roller arm extended position and a second roller arm retracted position, and a cutting assembly supported by the mounting plate. The cutting assembly includes a support arm pivotable relative to the mounting plate between a support arm extended position and a support arm retracted position, a cutting device mount pivotable relative to the support arm between a first position and a second position, and a biasing element that biases the cutting device mount to the first position.

Various embodiments of the present disclosure provide a tape cartridge cutting assembly for a case sealer. In one embodiment, the tape cartridge cutting assembly includes a support arm, a cutting device mount pivotable relative to the support arm between a first position and a second position, and a biasing element that biases the cutting device mount to the first position.

Other objects, features, and advantages of the present disclosure will be apparent from the detailed description and the drawings.

### BRIEF DESCRIPTION OF THE FIGURES

FIG. 1 is a left-side elevational view of one example embodiment of a case sealer of the present disclosure.

FIG. 2 is a perspective view of one example embodiment of a tape cartridge of the present disclosure with its front roller arm, its rear roller arm, and its support arm in their extended positions.

FIG. 3 is a perspective view of the tape cartridge of FIG. 2 (with certain elements removed) with its front roller arm, its rear roller arm, and its support arm in their extended positions.

FIG. 4 is a left-side elevational view of the tape cartridge of FIG. 2 (with certain elements removed) with its front roller arm, its rear roller arm, and its support arm in their extended positions.

FIG. 5 is a left-side elevational view of the tape cartridge of FIG. 2 (with certain elements removed) with its front roller arm, its rear roller arm, and its support arm in their retracted positions.

FIG. 6 is a partially exploded perspective view of the cutting assembly of the tape cartridge of FIG. 2.

FIG. 7 is an exploded perspective view of the cutting assembly of FIG. 6.

FIGS. 8A, 8B, 8C, and 8D are back elevational, front elevational, left-side elevational, and right-side elevational views, respectively, of the cutting device mount pivot controller of the cutting assembly of FIG. 6.

FIGS. 9A, 9B, 9C, and 9D are front elevational, back elevational, right-side elevational, and left-side elevational views, respectively, of the cutting device mount of the cutting assembly of FIG. 6.

FIG. 10A is a cross-sectional side elevational view of the cutting device assembly of FIG. 6, taken substantially along line 10-10 of FIG. 6, showing the cutting device cover in its closed position and the cutting device mount in its first position.

FIG. 10B is a cross-sectional side elevational view of the cutting device assembly of FIG. 6, taken substantially along line 10-10 of FIG. 6, showing the cutting device cover in its open position and the cutting device mount in its first position.

FIG. 10C is a cross-sectional side elevational view of the cutting device assembly of FIG. 6, taken substantially along line 10-10 of FIG. 6, showing the cutting device cover in its open position and the cutting device mount in its second position.

FIG. 11A is a left-side elevational view of the tape cartridge of FIG. 2 (with certain elements removed) with its front roller arm, its rear roller arm, and its support arm in their extended positions and with a roll of packing tape mounted thereto. FIG. 11A shows a case approaching the tape cartridge for sealing.

FIG. 11B is a left-side elevational view of the tape cartridge of FIG. 2 (with certain elements removed) with its front roller arm, its rear roller arm, and its support arm in their retracted positions and with a roll of packing tape mounted thereto. FIG. 11B shows the cutting device cover between its closed and open positions. FIG. 11B also shows the tape cartridge applying packing tape to the top surface of the case.

FIG. 11C is a left-side elevational view of the tape cartridge of FIG. 2 with a roll of packing tape mounted thereto (and with certain elements removed) as its support arm is returning from its retracted position to its extended position and the toothed blade of the cutting device contacts the packing tape.

FIG. 11D is a left-side elevational view of the tape cartridge of FIG. 2 with a roll of packing tape mounted thereto (and with certain elements removed) shortly after the toothed blade of the cutting device has contacted the packing tape and the cutting device mount has pivoted to the second position.

FIG. 11E is a left-side elevational view of the tape cartridge of FIG. 2 with a roll of packing tape mounted thereto(and with certain elements removed) shortly after the toothed blade of the cutting device has severed the packing tape.

FIG. 11F is a left-side elevational view of the tape cartridge of FIG. 2 with a roll of packing tape mounted thereto (and with certain elements removed) after the cartridge has sealed the case.

### DETAILED DESCRIPTION

Various embodiments of the present disclosure provide a case sealer including a tape cartridge with a pivotable cutting device.

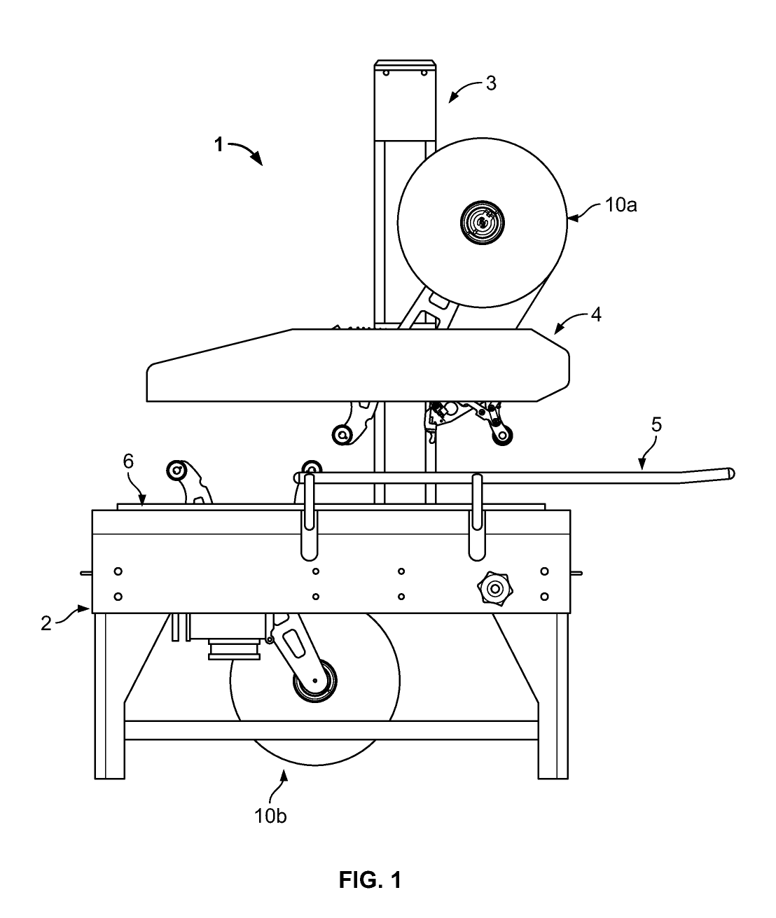

FIG. 1 illustrates one embodiment of the case sealer 1 of the present disclosure. The case sealer 1 includes: (1) a frame assembly 2; (2) a mast assembly 3 attached to and extending upwardly from the frame assembly 2; (3) a top head assembly 4 attached to the mast assembly 3; (4) multiple movable case-engaging side rails 5 (one of which is shown in FIG. 1) configured to center a case inthe case sealer 1; (5) a drive assembly 6 supported by the frame assembly 2 and including a belt and a motor (not shown) operatively connected to the belt to drive the belt; (6) an upper tape cartridge 10a attached to the top head assembly 4 and configured to apply packing tape to a leading surface, a top surface, and a trailing surface of the case; (7) a lower tape cartridge 10b attached to the frame assembly 2 and configured to apply packing tape to the leading surface, the bottom surface, and the trailing surface of the case; (8) a sensor (not shown) configured to detect the case; and (9) a controller (not shown) operatively coupled to the sensor and to the drive assembly to activate the motor to drive the belt responsive to the sensor detecting the case.

The sensor may be, for instance, an optical sensor, a mechanical switch, or a pressure sensor, and is configured to detect the presence of a case to-be-sealed and to send a signal to the controller that indicates the presence or absence of the case. The controller may be any known controller or control system and incorporate microprocessors and other circuitry to process the signal from the sensor and control the operation of the drive assembly (and in particular the motor).

The case sealer 1 is merely one example case sealer that may employ the tape cartridge of the present disclosure. The tape cartridge is usable with other case sealers that may have fewer or additional components, such as folding mechanisms configured to fold down the case's flaps before applying packing tape or multiple rollers to facilitate movement of the case to and from the drive assembly.

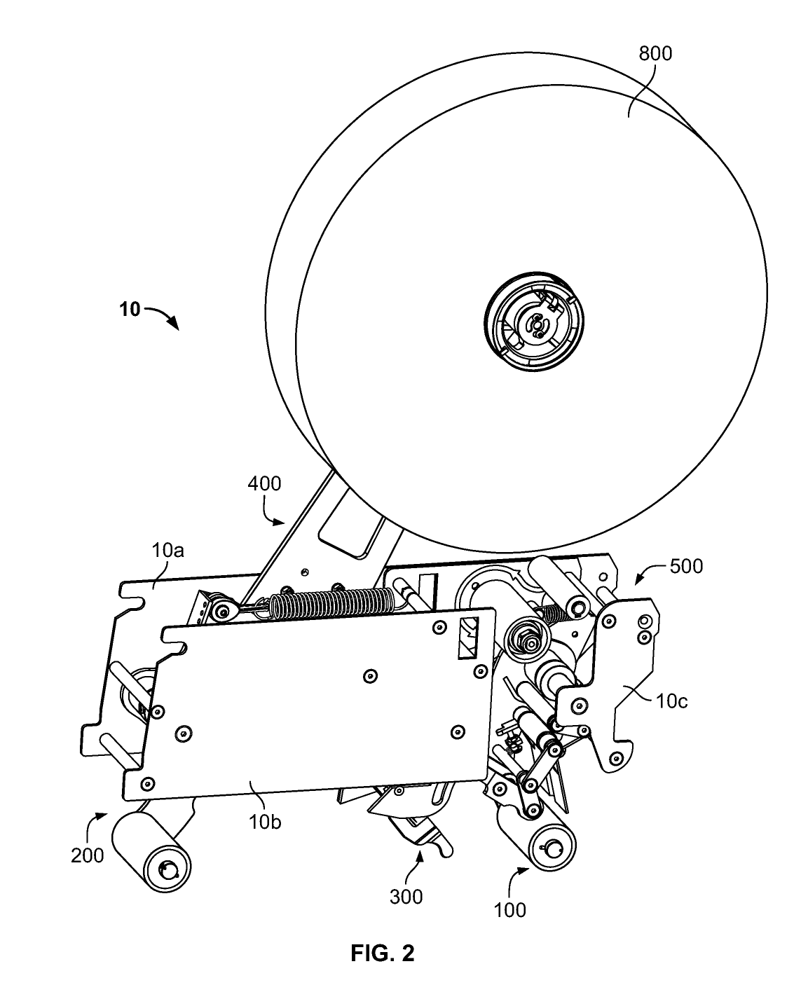

FIGS. 2-5 illustrate one example embodiment of the cartridge 10. The cartridge 10 includes a first mounting plate 10a that supports a front roller arm assembly 100, a rear roller arm assembly 200, a cutting assembly 300, a tape mounting assembly 400, and a tension roller assembly 500. As best shown in FIG. 2, a second mounting plate 10b and a third mounting plate 10c are attached to the first mounting plate 10a via multiple spacers and fasteners (not labeled) to partially enclose certain elements of the front roller arm assembly 100, the rear roller arm assembly 200, the cutting assembly 300, the tape mounting assembly 400, and the tension roller assembly 500 therebetween.

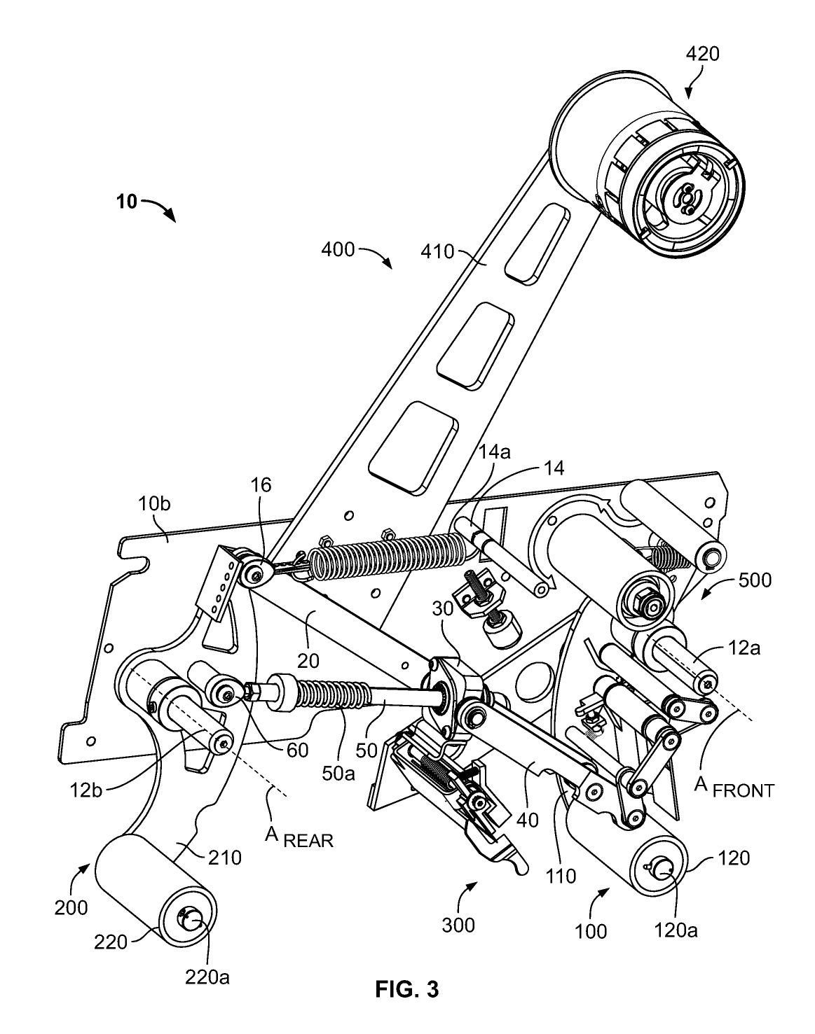

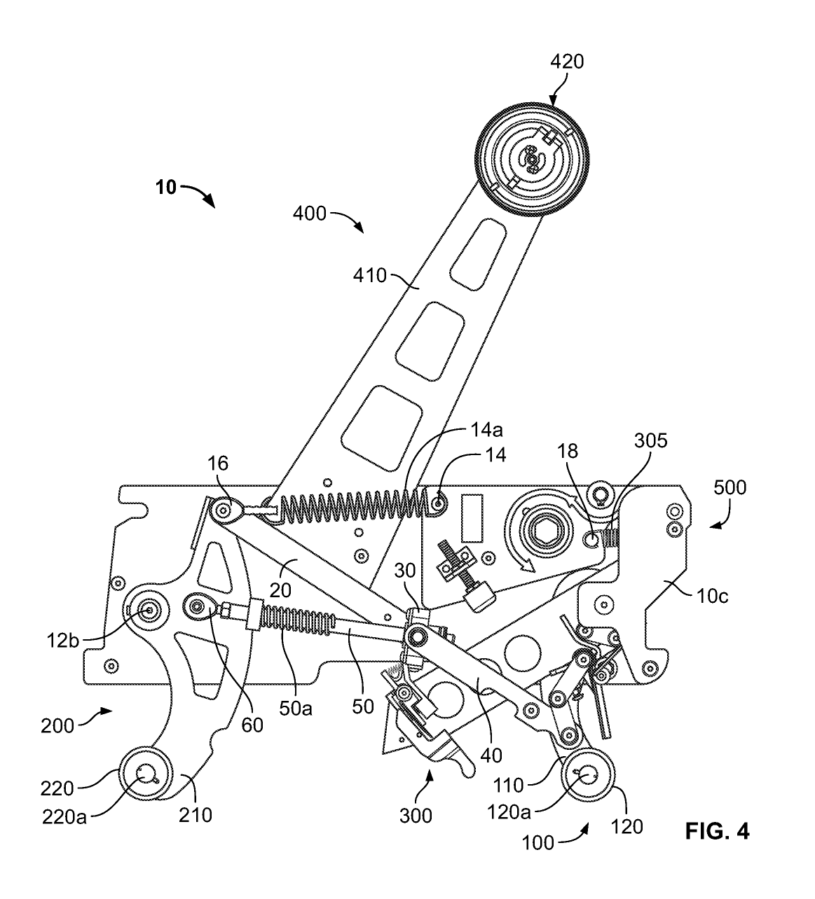

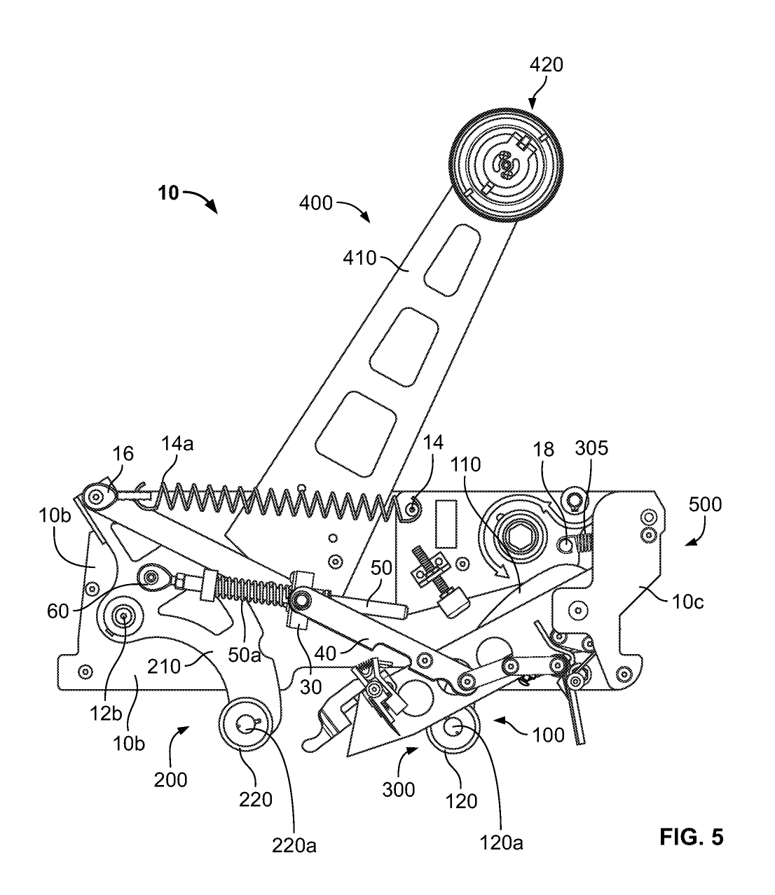

As best shown in FIGS. 3-5, the front roller arm assembly 100 includes a front roller arm 110 and a front roller 120. The front roller arm 110 is pivotably mounted to the first mounting plate 10a via a front roller arm pivot shaft 12a such that the front roller arm 110 can pivot relative to the mounting plate 10a about an axis A_{FRONT} between a front roller arm extended position (FIGS. 3 and 4) and a front roller arm retracted position (FIG. 5). The front roller arm 110 includes a front roller mounting shaft 120a, and the front roller 120 is rotatably mounted to the front roller mounting shaft 120a such that the front roller 120 can rotate relative to the front roller mounting shaft 120a.

As best shown in FIGS. 3-5, the rear roller arm assembly 200 includes a rear roller arm 210 and a rear roller 220. The rear roller arm 210 is pivotably mounted to the first mounting plate 10 via a rear roller arm pivot shaft 12b such that the rear roller arm 210 can pivot relative to the mounting plate 10a about an axis A_{REAR} between a rear roller arm extended position (FIGS. 3 and 4) and a rear roller arm retracted position (FIG. 5). The rear roller arm 210 includes a rear roller mounting shaft 220a, and the rear roller 220 is rotatably mounted to the rear roller mounting shaft 220a such that the rear roller 220 can rotate relative to the rear roller mounting shaft 220a.

As best shown in FIGS. 3-5, a rigid first linking member 20 is attached to and extends between the first roller arm 110 and the second roller arm 210. The first linking member 20 links the two roller arm assemblies such that: (1) moving the front roller arm 110 from the front roller arm assembly extended position to the front roller arm assembly retracted position causes the first linking member 20 to force the rear roller arm 210 to move from the rear roller arm assembly extended position to the rear roller arm assembly retracted position (and vice-versa); and (2) moving the rear roller arm 210 from the rear roller arm assembly extended position to the rear roller arm assembly retracted position causes the first linking member 20 to force the front roller arm 110 to move from the front roller arm assembly extended position to the front roller arm assembly retracted position (and vice-versa).

As best shown in FIGS. 3-5, a first roller arm assembly biasing element 14a—here, an extension spring—has one end attached to a first roller arm assembly biasing element attachment post 14 attached to the first mounting plate 10a and another end attached to a connector 16 that's pivotably attached to the rear roller arm 210. The first roller arm assembly biasing element 14a biases the front and rear roller arms 110 and 210 (in part via the first linking member 20) to their extended positions best shown in FIGS. 3 and 4. This is merely one manner of biasing the front and rear roller arms to their extended positions, and any other suitable arrangement of components and/or combination of components may be employed to do so.

As best shown in FIGS. 3-5, a slide block 30 is pivotably connected on one side to the first linking member 20 and on the other side to a rigid second linking member 40, which is attached to the front roller arm assembly 100. A guide member 50 is slidably received in an opening defined through the slide block 30. One end of the guide member 50 is attached to a connector 60 pivotably attached to the rear roller arm 210. A second roller arm assembly biasing element 50a—here, a compression spring—is positioned around the guide member 50 and constrained between the connector 60 and the slide block 30. As the front and rear roller arms 110 and 210 move from their extended positions to their retracted positions, the slide block 30 and the guide member 50 move closer to one another (i.e., the guide member 50 extends further through the slide block 30). As best shown in FIG. 5, when the front and rear roller arms 110 and 210 are in their retracted positions, the connector 60 and the slide block 30 compress the second roller arm assembly biasing element 50a therebetween. This imparts another force (in addition to the biasing force the first roller assembly biasing element 14 imparts) that biases the front and rear roller arms 110 and 120 (in part via the first linking member 20) to return to their extended positions. This is merely one manner of biasing the front and rear roller arms to their extended positions, and any other suitable arrangement of components and/or combination of components may be employed to do so.

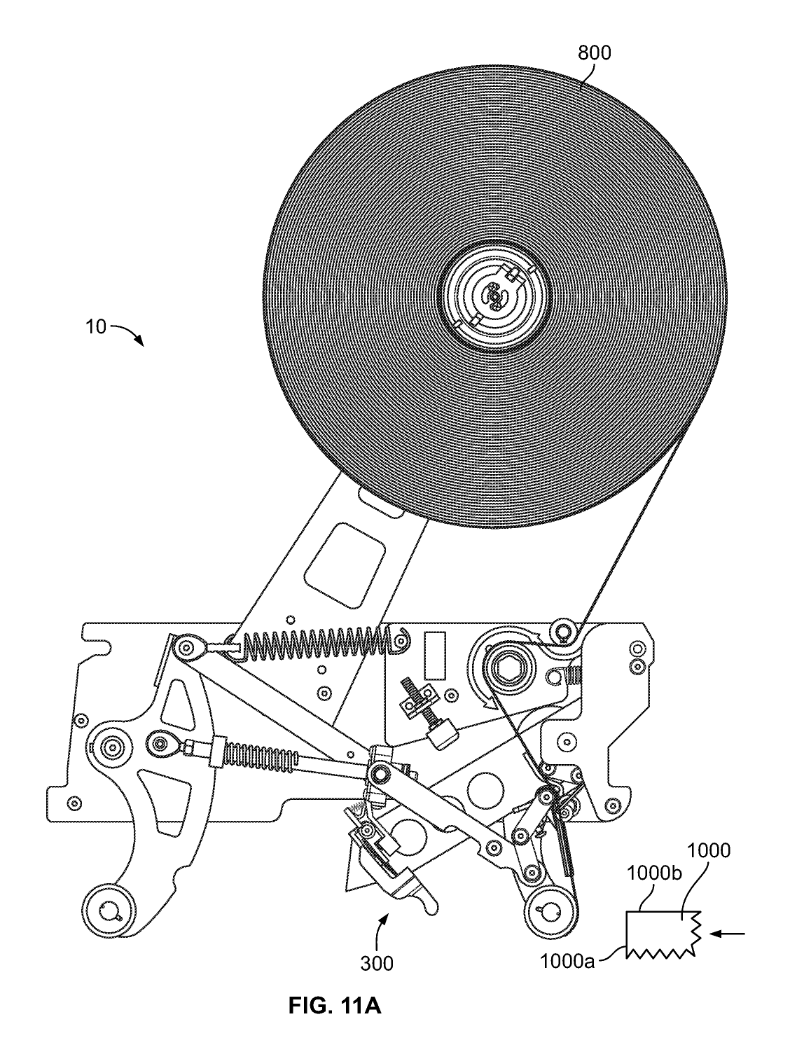

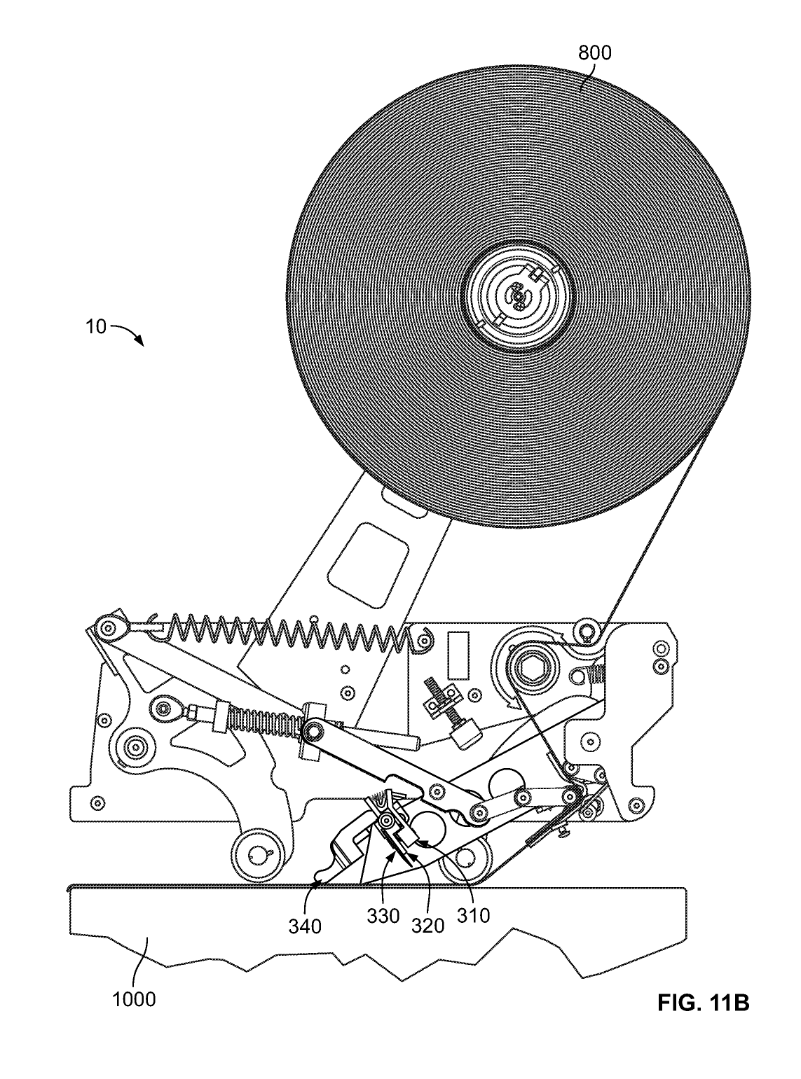

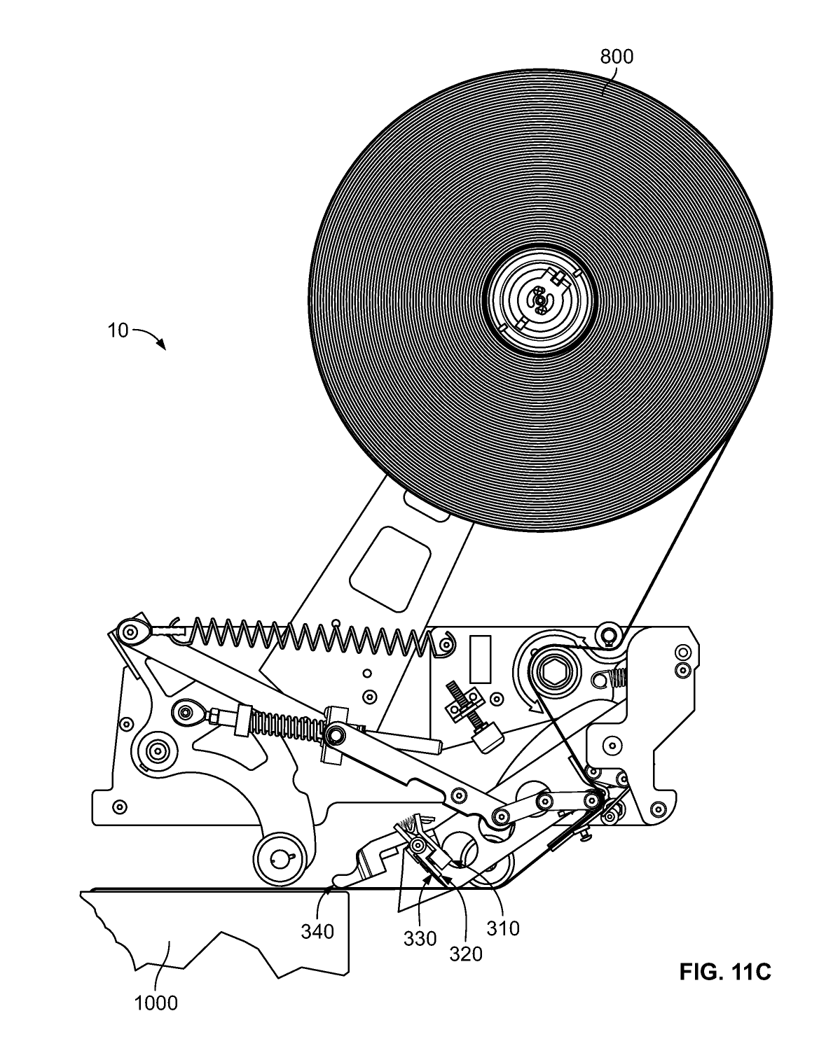

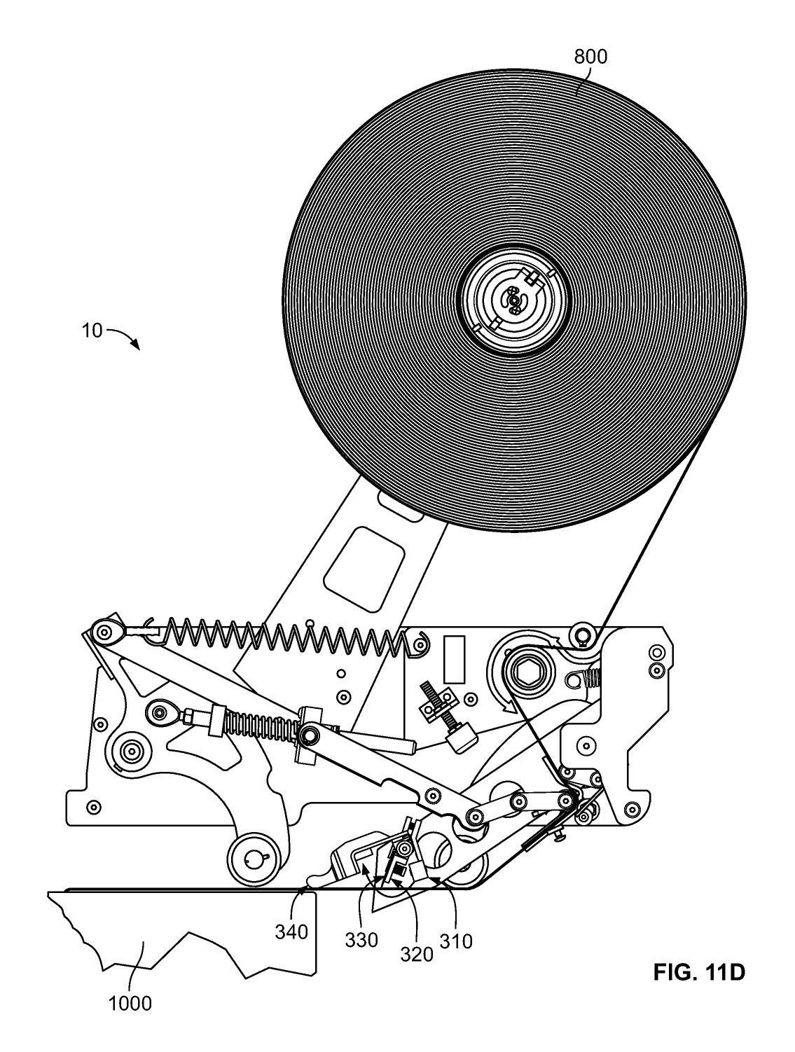

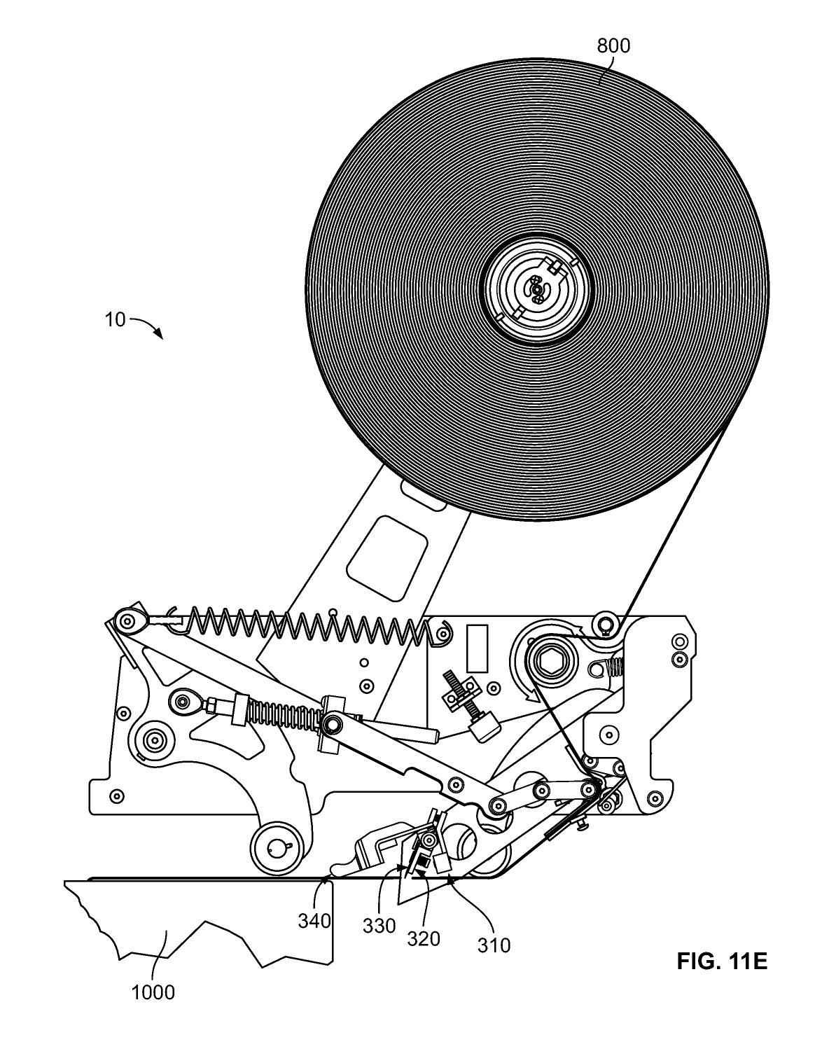

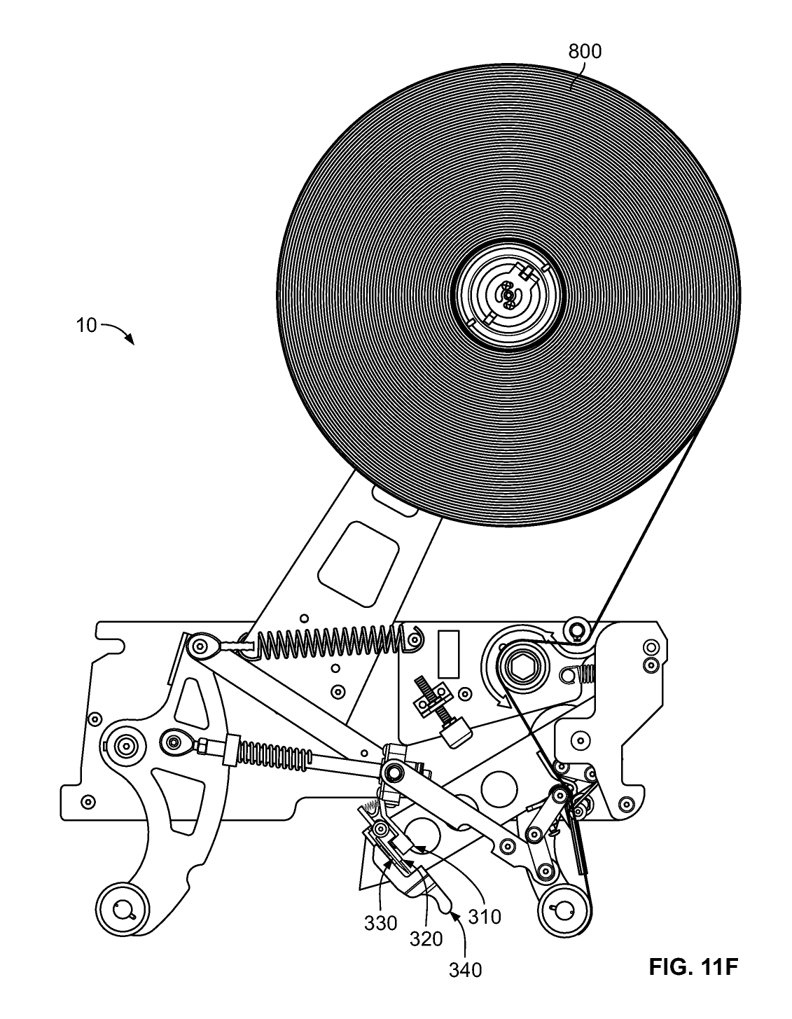

As best shown in FIGS. 3-5, the tape mounting assembly 400 includes a tape mounting plate 410 and a tape core mounting assembly 420 rotatably mounted to the tape mounting plate 410. A roll of packing tape, such as the roll 800 shown in FIGS. 2 and 11A-11F, is mountable to the tape core mounting assembly 420.

As best shown in FIGS. 3-5, the tension roller assembly 500 includes several rollers (not labeled) supported by the first mounting plate 10a. A free end of the roll 800 of packing tape mounted to the tape core mounting assembly is threadable through the rollers until the free end is adjacent the front roller 120 of the front roller arm assembly 110 with its adhesive side facing outward in preparation for adhesion to a case, as shown in FIG. 11A.

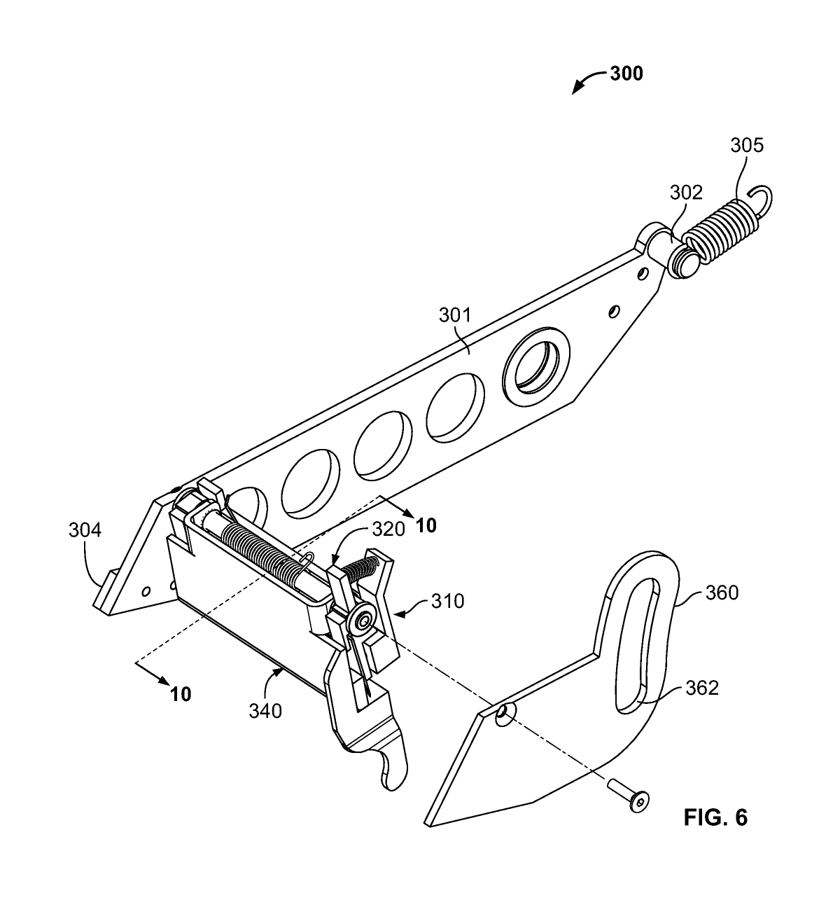

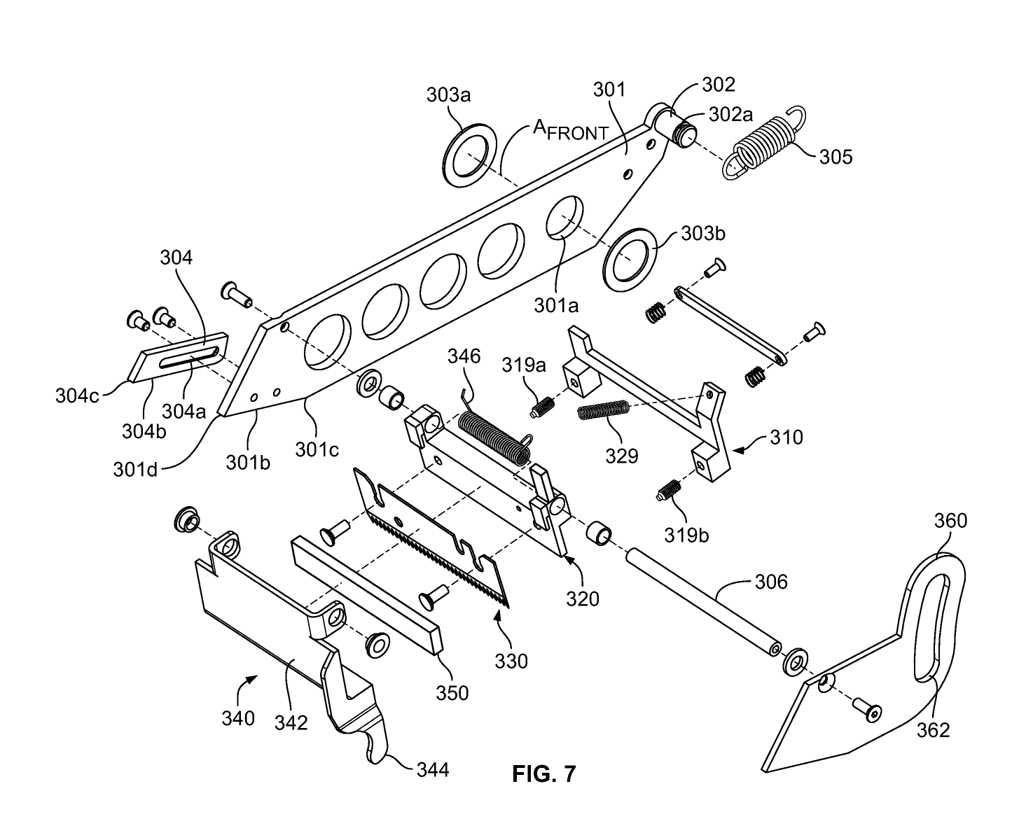

As best shown in FIGS. 6 and 7, the cutting assembly 300 includes a support arm 301, an extension plate 304, a support arm biasing element 305, a cutting device and cutting device cover pivot shaft 306, a cutting device mount pivot controller 310, a cutting device mount 320, a cutting device 330, a cutting device cover 340, a cutting device pad 350, and a rotation-control plate 360.

The support arm 301 includes a cylindrical surface 301a that defines a support arm mounting opening. The support arm 301 also includes a planar case-contact surface 301b partially defined by a transverse leading edge 301c and a transverse trailing edge 301d. As best shown in FIGS. 3-5, the support arm 301 is pivotably mounted (via the support arm mounting opening) to the first mounting plate 10a via the front roller arm pivot shaft 12a and bushings 303a and 303b such that the support arm 301 can pivot relative to the mounting plate 10a about the axis A_{FRONT} between a support arm extended position (FIGS. 3 and 4) and a support arm retracted position (FIG. 5).

As best shown in FIGS. 6 and 7, a mounting post 302 extends from the end of the support arm 301 opposite the case-contact surface 301b. The mounting post 302 defines a circumferential groove 302a sized to receive and retain a hook at one end of the support arm biasing element 305, which is an extension spring in this example embodiment. As best shown in FIGS. 4 and 5, the hook at the other end of the support arm biasing element 305 is attached to a support arm biasing element mounting post 18 supported by the mounting plate 10a. The support arm biasing element 305 biases the support arm 301 to the extended position best shown in FIGS. 3 and 4. This is merely one manner of biasing the support arm to its extended position, and any other suitable arrangement of components and/or combination of components may be employed to do so.

As best shown in FIG. 7, the extension plate 304 includes a slot-defining surface 304a that defines a position-adjustment slot through the extension plate 304. The extension plate 304 also includes a planar case-contact surface 304b partially defined by a trailing edge 304c. The extension plate 304 is attachable to the support arm 301 via multiple fasteners (not labeled) that extend through the position-adjustment slot and into threaded fastener-receiving openings (not labeled) defined inthe support arm 301. The position-adjustment slot enables one to change the position of the extension plate 304 relative to the support arm 301 between a retracted position and an extended position. In the retracted position, as shown in FIG. 6, the trailing edge 304c of the extension plate 304 does not extend past (and in this embodiment is coaxial with) the trailing edge 301d of the support arm 301. In the extended position (not shown), the trailing edge 304c of the extension plate 304 extends past the trailing edge 301d of the support arm 301. This effectively lengthens the case-contacting surface of the support arm 301, and results in a longer trailing end of the packing tape after severing.

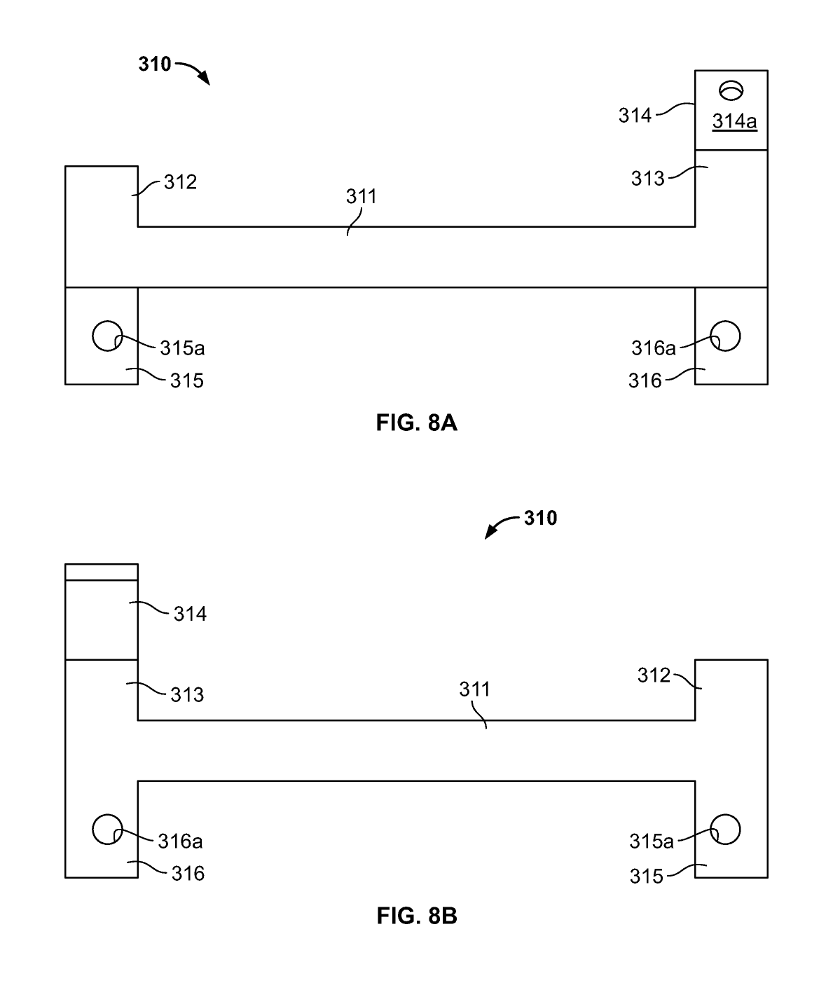

As best shown in FIGS. 8A-8D, the cutting device mount pivot controller 310 is generally H-shaped and includes a rectangular transverse portion 311, a rectangular first upper portion 312 extending upward from a first end of the transverse portion 311, a rectangular second upper portion 313 extending upward from a second opposing end of the transverse potion 311, a rectangular cutting device biasing element seating portion 314 extending upward from the second upper portion 313 and angled toward the mounting post 302, a rectangular first stop portion 315 extending downward from the first end of the transverse portion 311, and a rectangular second stop portion 316 extending downward from the second end of the transverse portion 311.

The cutting device biasing element seating portion 314 has a seating surface 314a that includes or defines a cutting device biasing element seat, which is a bore in this embodiment but may be a boss or any other suitable element in other embodiments. The cutting device biasing element seat is configured to retain one end of a cutting device biasing element 329, which is a compression spring in this example embodiment.

The first stop portion 315 includes a first cylindrical surface 315a defining a threaded set screw receiving opening sized to receive a first set screw 319a, and the second stop portion 316 includes a second cylindrical surface 316a defining a threaded set screw receiving opening sized to receive a second set screw 319b. As described below, the set screws 319a and 319b are used to define the first position of the cutting device mount 320 (and therefore the first position of the cutting device 330).

As best shown in FIGS. 6 and 7, the cutting device mount pivot controller 310 is attached to and extends transversely to the support arm 301. In this embodiment, the cutting device mount pivot controller 310 is fixedly attached to (such as welded to) the support arm 301, though in other embodiments the components may be removably attached to one another.

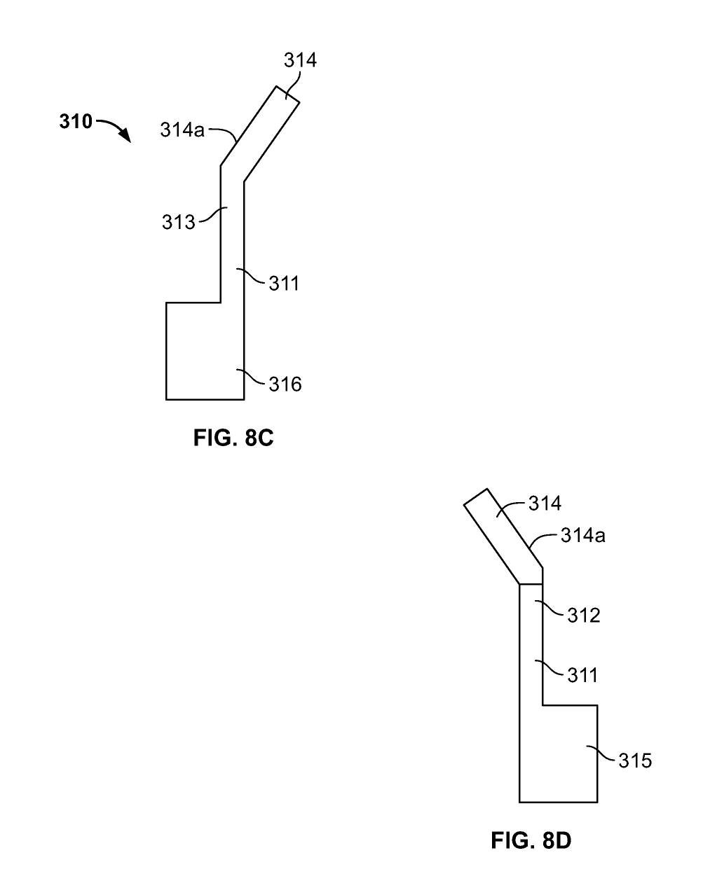

As best shown in FIGS. 9A-9D, the cutting device mount 320 includes a transverse portion 321 having a cutting device contact surface 321a and an opposing surface 321b, a first mounting element 322 at a first end of the transverse portion 321, a second mounting element 323 at a second opposing end of the transverse portion 321, a cutting device biasing element seating portion 324 extending upward from the first mounting element 322, a first cutting device retaining finger 325 opposite the first mounting element 322, and a second cutting device retaining forger 326 opposite the second mounting element 323,

The cutting device biasing element seating portion 324 has a seating surface 324a that includes or defines a cutting device biasing element seat, which is a bore in this embodiment but may be a boss or any other suitable element in other embodiments. The cutting device biasing element seat is configured to retain the other end of the cutting device biasing element 329 such that the cutting device biasing element 329 is constrained between the cutting device biasing element seating portions 314 and 324, as shown in FIG. 6.

The transverse portion 321 includes two cylindrical surfaces 321c and 321d that each define a cutting device mounting post receiving opening used to releasably mount the cutting device 330 to the cutting device mount 320. The first mounting element 322 includes a first cylindrical surface 322a that defines a first mounting opening, and the second mounting element 323 includes a second cylindrical surface 323a that defines a second mounting opening.

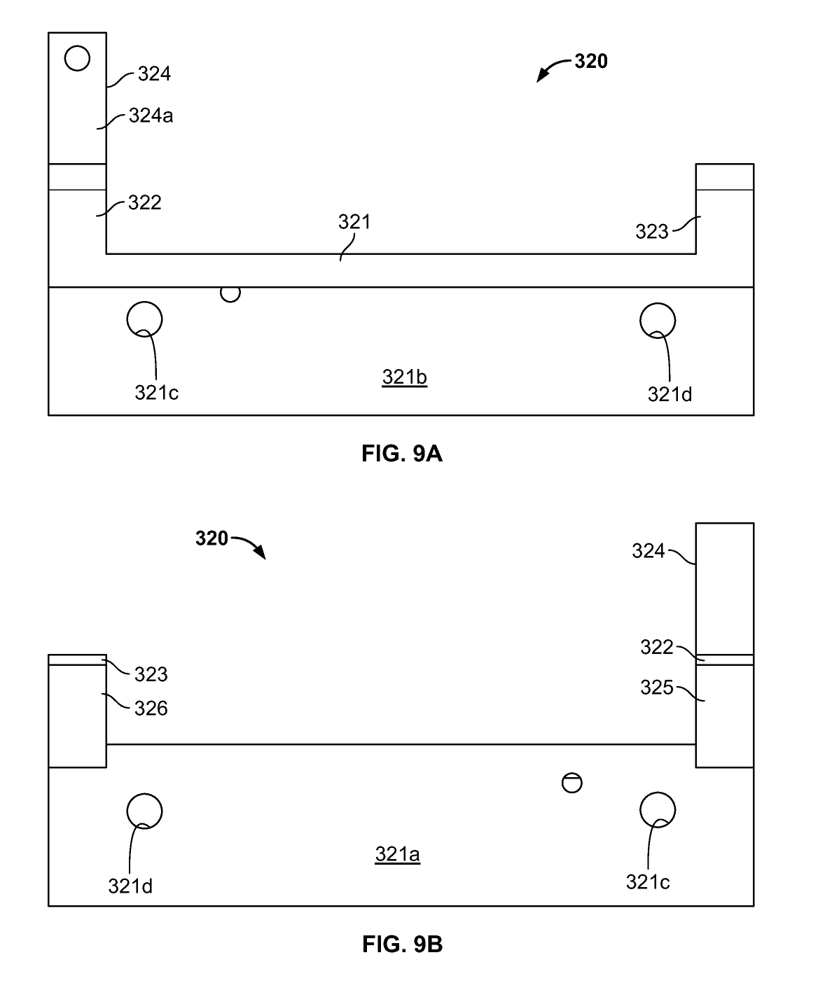

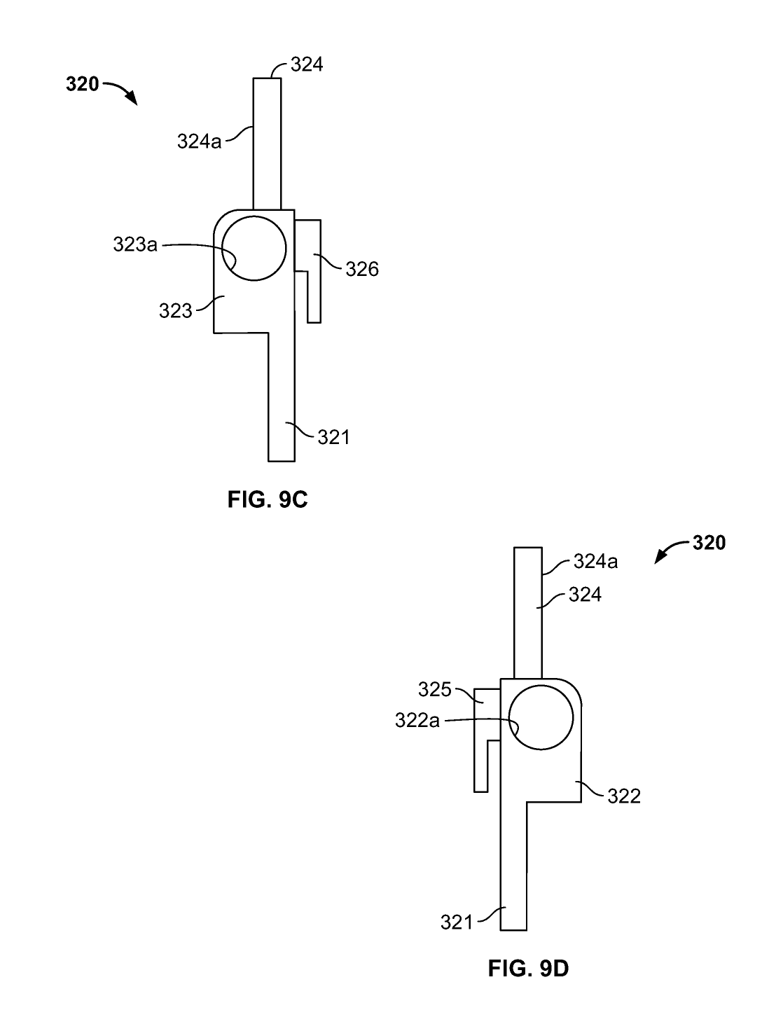

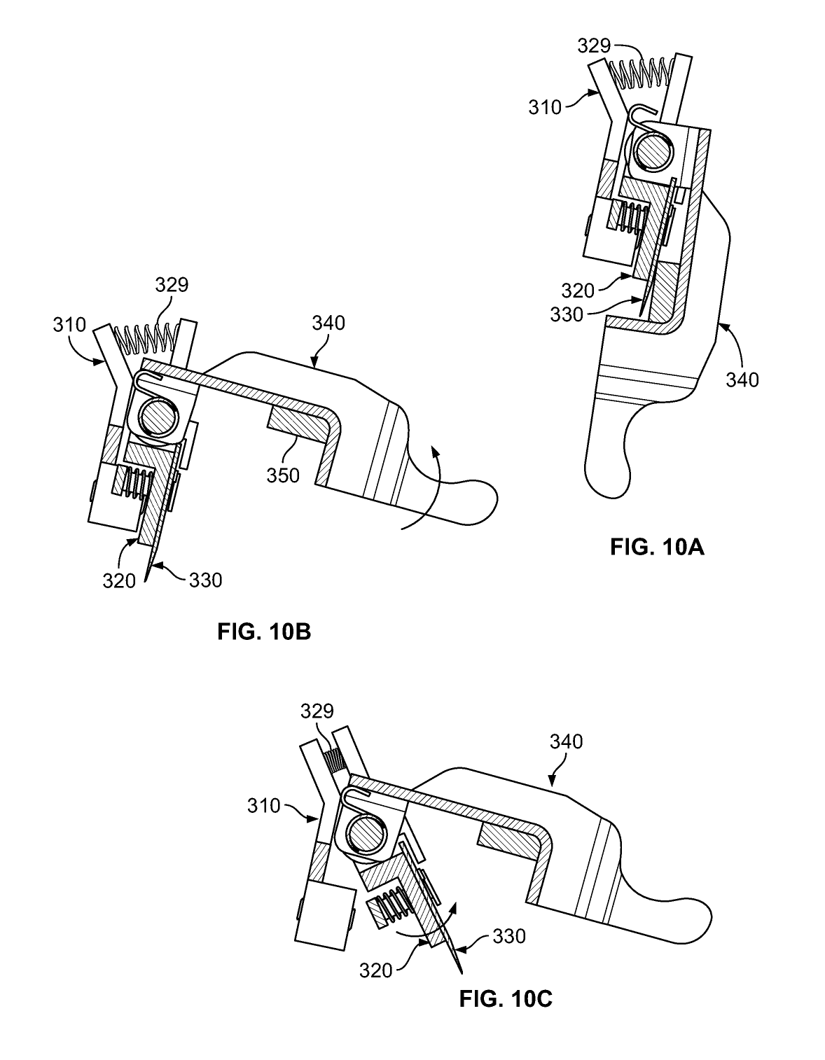

As best shown in FIGS. 6 and 7, the cutting device mount 320 is pivotably mounted to the support arm 310 via the mounting openings and the cutting device and cutting device cover pivot shaft 306, which is itself attached to the support arm 301 via a suitable fastener. Once attached, the cutting device mount 320 is pivotable about an axis A_{BLADE, COVER} relative to the support arm 301 and to the cutting device mount pivot controller 310 from front to back and back to front between a first or rest position and a second or fully pivoted position. FIGS. 10A and 10B show the cutting device mount inthe first position and FIG. 10C shows the cutting device mount inthe second position. The cutting device biasing element 329 biases the cutting device mount 320 to the first position, and when inthe first position, the surface 321b of the cutting device mount 320 contacts the free ends of the set screws 319a and 319b threadably received by the cutting device mount pivot controller 310. Adjustment of the set screws 319 (e.g., further threading into or out of their corresponding openings) adjusts the first position of the cutting device mount 320. When inthe second position, the cutting device biasing element 329 is compressed and the surfaces 314a and 324a are adjacent one another. Accordingly, the cutting device mount pivot controller 310 is sized, shaped, positioned, or otherwise configured to constrain the cutting device mount 320 between the home and the second positions. This is merely one manner of biasing the cutting device to its first position, and any other suitable arrangement of components and/or combination of components may be employed to do so. The cutting assembly may include any other suitable adjustment component or components that enable adjustment of the first position of the cutting device mount.

As best shown in FIG. 7, the cutting device 330 includes a toothed blade (not labeled) configured to sever packing tape. The cutting assembly includes a cutting device mounting assembly configured to removably mount the cutting device to the cutting device mount 320 in the manner described in U.S. Pat. No. 8,079,395, though the cutting device 330 may be mounted to the cutting device mount 320 in any other suitable manner

As best shown in FIGS. 6 and 7, the cutting device cover 340 includes a body 342 and a finger 344 extending from the body 342. A pad 350 is attached to the body 342. The cutting device cover 340 is pivotably mounted to the support arm 310 via mounting openings (not labeled) and the cutting device and cutting device cover pivot shaft 306. Once attached, the cutting device cover 340 is pivotable about the axis A_{BLADE, COVER} relative to the support arm 301, the cutting device mount pivot controller 310, and the cutting device mount 320 from front to back and back to front between a closed position an open position. FIG. 10A shows the cutting device cover in the closed position and FIGS. 10A and 10B show the cutting device cover in the open position. A cutting device cover biasing element 346, which is a torsion spring in this example embodiment, biases the cutting device cover to the closed position. When in the closed position, the cutting device cover 340 generally encloses the cutting device 330 such that the pad 350 contacts the toothed blade of the cutting device 330. When in the open position, the cutting device cover 340 exposes the cutting device 330 and its toothed blade.

As best shown in FIGS. 6 and 7, the cutting device and cutting device cover pivot shaft 306 is also attached to the rotation-control plate 360. The rotation-control plate 360 includes a slot-defining surface 362 that defines a slot. The slot acts as a guide (not shown) for a bushing that is attached to the mounting plate 10b. The bushing provides lateral support for the cutting assembly 300 to generally prevent it from moving toward or away from the mounting plates 10a and 10b and interfering with other components of the cartridge 10 when in use.

FIGS. 11A-11F show the cartridge 10 applying packing tape from the roll 800 to a leading surface 1000a, a top surface 1000b, and a trailing surface 1000c of a case 1000.

FIG. 11A shows the cartridge 10 after the roll 800 of packing tape has been mounted to the tape core mounting assembly 420 of the tape mounting assembly 400 and the free end of the packing tape has been threaded through the rollers of the tension roller assembly 500 such that the free end is adjacent the front roller 120 of the front roller arm assembly 110 with its adhesive side facing outward in preparation for adhesion to the case. The drive assembly moves the case 1000 toward the cartridge 10 in preparation for sealing

FIG. 11B shows the cartridge 10 as it is applying the packing tape to the top surface 1000b of the case 1000. At this point, the front roller arm 110, the rear roller arm 210, and the support arm 301 are in their retracted positions, and the front roller 120, the rear roller 210, and the case-contact surface 301b are riding along the top surface 1000b of the case 1000. Also, the cutting device cover 340 is in its open position with the forger 344 riding along the top surface 1000b of the case 1000.

FIG. 11C shows the cartridge 10 after the trailing surface 1000c of the case 1000 has passed the trailing edge 301d of the support arm 301 and the support arm biasing element 305 has begun biasing the support arm 301 back to its extended position. At this point, the toothed blade of the cutting device 330 is just contacting the packing tape.

FIG. 11D shows the cartridge 10 just after the toothed blade of the cutting device 330 contacts the packing tape. The contact force causes the cutting device mount 320 to pivot relative to the support arm from the first position (shown in FIGS. 11A-11C) to the second position.

FIG. 11E shows the cartridge 10 in the second position just after the toothed blade of the cutting device 330 severs the packing tape.

FIG. 11F shows the cartridge 10 in the first position after the cartridge 10 has sealed the case 1000.

The fact that the cutting device mount pivots with the moving packing tape as the toothed blade of the cutting device penetrates and severs the packing tape provides two benefits: (1) reduced force imparted onto the teeth (as compared to the force imparted by a non-pivotable cutting device mount); and (2) a cleaner cut of the packing tape. Specifically, since the cutting device mount can pivot relative to the support arm, the teeth of the cutting device do not drag across the surface of the packing tape before severing it.

The reduced force imparted on the teeth extends the life of the cutting device since the teeth will take longer to bend or break (as compared to teeth of a cutting device mounted to a non-pivotable cutting device mount). This leads to less downtime for maintenance and lower operating costs since cutting devices will need to be replaced less often.

The fact that the cutting device does not generate shards (or generates far fewer shards) or adhesive buildup (or generates far less adhesive buildup) when severing the packing tape also leads to less downtime for maintenance since the cutting device will not need to be cleaned as often as compared to teeth of a cutting device mounted to a non-pivotable cutting device mount.

In various embodiments, the cutting device assembly or portions thereof may be retrofit onto existing tape cartridges to improve their functionality as described above.

Various changes and modifications to the above-described embodiments described herein will be apparent to those skilled in the art. These changes and modifications can be made without departing from the spirit and scope of this present subject matter and without diminishing its intended advantages. Not all of the depicted components described in this disclosure may be required, and some implementations may include additional, different, or fewer components from those expressly described in this disclosure. Variations inthe arrangement and type of the components; the shapes, sizes, and materials of the components; and the manners of attachment and connections of the components may be made without departing from the spirit or scope of the claims as set forth herein. Also, unless otherwise indicated, any directions referred to herein reflect the orientations of the components shown in the corresponding drawings and do not limit the scope of the present disclosure. This specification is intended to be taken as a whole and interpreted in accordance with the principles of the invention as taught herein and understood by one of ordinary skill inthe art.

1. A case sealer comprising:
a drive assembly configured to move a case; and
a tape cartridge configured to apply tape to the case, the tape cartridge comprising:
a mounting plate;
a first roller arm assembly supported by the mounting plate and comprising a first roller arm pivotable relative to the mounting plate between a first roller arm extended position and a first roller arm retracted position;
a second roller arm assembly supported by the mounting plate and comprising a second roller arm pivotable relative to the mounting plate between a second roller arm extended position and a second roller arm retracted position; and
a cutting assembly supported by the mounting plate and comprising:
a support arm pivotable relative to the mounting plate between a support arm extended position and a support arm retracted position;
a cutting device mount pivotable relative to the support arm between a first position and a second position; and
a biasing element that biases the cutting device mount to the first position.

2. The case sealer of claim 1, wherein the cutting assembly further comprises a cutting device mount pivot controller attached to the support arm and positioned relative to the cutting device mount to constrain the cutting device mount between the home and the second positions.

3. The case sealer of claim 2, wherein the biasing element comprises a spring, wherein the cutting device mount comprises a first spring retainer, wherein the cutting device mount pivot controller comprises a second spring retainer, wherein the first and second spring retainers retain the spring therebetween.

4. The case sealer of claim 1, further comprising a cutting device mounting assembly configured to removably mount a cutting device to the cutting device mount.

5. The case sealer of claim 1, wherein the cutting assembly further comprises a pivot shaft attached to the support arm, wherein the cutting device mount is mounted to the pivot shaft.

6. The case sealer of claim 5, wherein the cutting assembly further comprises a cutting device cover mounted to the pivot shaft and pivotable relative to the support arm and relative to the cutting device mount between a closed position in which the cutting device cover at least partially encloses a portion of the cutting device mount and an open position in which the cutting device cover does not enclose the portion of the cutting device mount.

7. A tape cartridge for a case sealer, the tape cartridge comprising:
a mounting plate;
a first roller arm assembly supported by the mounting plate and comprising a first roller arm pivotable relative to the mounting plate between a first roller arm extended position and a first roller arm retracted position;
a second roller arm assembly supported by the mounting plate and comprising a second roller arm pivotable relative to the mounting plate between a second roller arm extended position and a second roller arm retracted position; and
a cutting assembly supported by the mounting plate and comprising:
a support arm pivotable relative to the mounting plate between a support arm extended position and a support arm retracted position;
a cutting device mount pivotable relative to the support arm between a first position and a second position; and
a biasing element that biases the cutting device mount to the first position.

8. The tape cartridge of claim 7, wherein the cutting assembly further comprises a cutting device mount pivot controller attached to the support arm and positioned relative to the cutting device mount to constrain the cutting device mount between the home and the second positions.

9. The tape cartridge of claim 8, wherein the biasing element comprises a spring, wherein the cutting device mount comprises a first spring retainer, wherein the cutting device mount pivot controller comprises a second spring retainer, wherein the first and second spring retainers retain the spring therebetween.

10. The tape cartridge of claim 9, wherein at least one of the first and second spring retainers is one of: an opening and a boss.

11. The tape cartridge of claim 7, wherein the cutting assembly further comprises a pivot shaft attached to the support arm, wherein the cutting device mount is mounted to the pivot shaft.

12. The tape cartridge of claim 11, wherein the cutting assembly further comprises a cutting device cover mounted to the pivot shaft and pivotable relative to the support arm and relative to the cutting device mount between a closed position in which the cutting device cover at least partially encloses a portion of the cutting device mount and an open position in which the cutting device cover does not enclose the portion of the cutting device mount.

13. A tape cartridge cutting assembly for a case sealer, the cutting assembly comprising:
a support arm;
a cutting device mount pivotable relative to the support arm between a first position and a second position; and
a biasing element that biases the cutting device mount to the first position.

14. The cutting assembly of claim 13, further comprising a cutting device mount pivot controller attached to the support arm and positioned relative to the cutting device mount to constrain the cutting device mount between the home and the second positions.

15. The cutting assembly of claim 14, wherein the biasing element comprises a spring, wherein the cutting device mount comprises a first spring retainer, wherein the cutting device mount pivot controller comprises a second spring retainer, wherein the first and second spring retainers retain the spring therebetween.

16. The cutting assembly of claim 15, wherein at least one of the first and second spring retainers is one of: an opening and a boss.

17. The cutting assembly of claim 13, further comprising a cutting device removably attachable to the cutting device mount.

18. The cutting assembly of claim 13, further comprising a pivot shaft attached to the support arm, wherein the cutting device mount is mounted to the pivot shaft.

19. The cutting assembly of claim 18, further comprising a cutting device cover mounted to the pivot shaft and pivotable relative to the support arm and relative to the cutting device mount between a closed position in which the cutting device cover at least partially encloses a portion of the cutting device mount and an open position in which the cutting device cover does not enclose the portion of the cutting device mount.

20. The cutting assembly of claim 19, further comprising a second biasing element that biases the cutting device cover to the closed position.
